(19) United States
(12) Patent Application Publication
(10) Pub. No.: US 2016/0328945 A1
(43) Pub. Date: Nov. 10, 2016

(54) Apparatus and Method For Remote Monitoring, Assessing and Diagnosing of Climate Control Systems

(71) Applicant: Wireless Network Group, Inc., Pompton Plains, NJ (US)

(72) Inventors: Harry Greisser, Flanders, NJ (US); Lee Mingione, Hazlet, NJ (US); Michael Fox, Mahwah, NJ (US)

(21) Appl. No.: 14/707,516

(22) Filed: May 8, 2015

(51) Int. Cl. G08B 21/18; H04W 24/04; G08B 3/10

(52) U.S. Cl. CPC G08B 21/182; G08B 3/10; H04W 24/04

(57) ABSTRACT

An apparatus and method for monitoring operation of HVAC units associated with cell towers has a plurality of sensors sensing operating parameters of the HVAC units and communicating the data via a wireless data logger to a computer programmed to analyze the data to predict impending out-of-range operating conditions and warn a user. The analysis may be by pattern recognition and/or rules. The system may generate prescriptive measures to remedy expected degraded operation and is applicable to any number of cell tower installations.

### CROSS-REFERENCE TO RELATED APPLICATIONS

The present application claims the benefit of U.S. Provisional Application No. 61/990,333, filed on May 8, 2014, entitled Apparatus and Method for Remote Monitoring, Assessing and Diagnosing of Climate Control Systems and U.S. Provisional Application No. 62/023,325, filed on Jul. 11, 2014, entitled Apparatus and Method for Remote Monitoring, Assessing and Diagnosing of Climate Control Systems, the disclosures of which are incorporated herein by reference in their entireties for all purposes.

### FIELD

The present invention relates to environmental control and monitoring systems such as heating, cooling, dehumidifying and humidifying systems, and more particularly, to monitoring, assessing, diagnosing and maintaining HVAC systems.

### BACKGROUND

Apparatus for monitoring the condition within a structure such as the presence of fire, water, smoke, intrusion or high/low temperature in a building and generating an alarm to a remotely located personnel are known. For example, security systems that will trigger a telephone call in the event of a fire or burglary are known. Notwithstanding, improved and/or alternative monitoring apparatus and methods remain desirable.

### SUMMARY

The disclosed subject matter relates to a system for monitoring operation of remote apparatus having at least one sensor capable of sensing at least one operating parameter of the apparatus and generating data corresponding to the at least one operating parameter at a plurality of times; a computer programmed to analyze the data to predict impending out-of-range operating conditions for the apparatus; and means for communicating the data from the at least one sensor to the computer, the computer capable of communicating the prediction of impending out-of-range operation to a user.

In accordance with another aspect of the present disclosure, the computer is programmed to predict impending out of range operation based upon data corresponding to the at least one operating parameter.

In accordance with another aspect of the present disclosure, the apparatus is HVAC equipment.

In accordance with another aspect of the present disclosure, the HVAC equipment is installed in a structure controlling the temperature of electronic equipment associated with a communications cell tower.

In accordance with another aspect of the present disclosure, the means of communicating the data is a data logger.

In accordance with another aspect of the present disclosure, the data logger communicates wirelessly via a cell phone call.

In accordance with another aspect of the present disclosure, the at least one sensor includes a plurality of sensors, each capable of sensing on a different operating parameter of the apparatus.

In accordance with another aspect of the present disclosure, the at least one sensor includes a plurality of sensors, each capable of sensing on a different operating parameter of the apparatus, including sensors for sensing supply and return air temperature and air flow velocity.

In accordance with another aspect of the present disclosure, the computer is capable of ascertaining a diagnosis of the cause of the impending out-of-range operating conditions for the apparatus and communicating the diagnosis to the user.

In accordance with another aspect of the present disclosure, the computer is capable of prescribing a course of action to the user to remedy the impending out-of-range operating conditions for the apparatus before they occur.

In accordance with another aspect of the present disclosure, the course of action is expressed in a directive to a service technician.

In accordance with another aspect of the present disclosure, the directive includes a repair parts list.

In accordance with another aspect of the present disclosure, the prediction of impending out-of-range operation communicated to a user is expressed as an alarm state having a selected urgency indication.

In accordance with another aspect of the present disclosure, the at least one sensor includes sensors capable of sensing on at least one of fan cycles, lead/lag, refrigerant pressure and refrigerant temperature.

In accordance with another aspect of the present disclosure, the at least one sensor includes sensors capable of sensing on at least one of conditions of the environment and conditions of the structure in which the HVAC unit is installed.

In accordance with another aspect of the present disclosure, the analysis conducted by the computer is a rules based analysis.

In accordance with another aspect of the present disclosure, the analysis conducted by the computer utilizes pattern recognition.

In accordance with another aspect of the present disclosure, the analysis conducted by the computer utilizes empirical data collected from operation of the apparatus.

In accordance with another aspect of the present disclosure, the analysis conducted by the computer utilizes empirical data collected from operation of other apparatus similar to the apparatus.

In accordance with another aspect of the present disclosure, the out-of-range operating condition is identified from at least one of temperature differential between return air temperature and supply air temperature and air flow.

### BRIEF DESCRIPTION OF THE DRAWINGS

For a more complete understanding of the present disclosure, reference is made to the following detailed description of exemplary embodiments considered in conjunction with the accompanying drawings.

FIG. 1 is a schematic diagram of a system in accordance with an embodiment of the present disclosure.

FIG. 2 is a schematic diagram of an air conditioner monitored by the system of FIG. 1.

FIG. 3 is a schematic diagram of an architecture, including software components, of the system of FIGS. 1 and 2.

FIGS. 4-9 are screenshots of screens from the graphical user interface of the system of FIG. 1.

### DETAILED DESCRIPTION OF EXEMPLARY EMBODIMENTS

An aspect of the present disclosure is the recognition that monitoring systems which trigger an alarm after an end state condition exceeds a set point may be useful in warning of a problematic condition after it has occurred, but in many instances, it would be preferable to warn of impending problematic conditions before they occur. This is true, e.g., in the context of monitoring HVAC systems that control environmental conditions in a building or structure and, in particular, where the structure houses residents, businesses, mechanical, electrical or hydraulic systems and infrastructure that may be adversely affected if the HVAC system does not work properly. For example, in the case of a residence, a freeze condition may occur breaking water pipes and sanitary fixtures and disturbing the habitability of the premises. In the case of apartment buildings, condominiums, malls, office buildings, etc. with shared HVAC apparatus, the malfunction of HVAC systems can cause significant inconvenience and expense for the residents and for the property owner. The same can be said of industrial or commercial buildings where business may be interrupted and/or expensive equipment can be damaged or put out of service due to HVAC failure. This condition is particularly acute in circumstances where the environmentally controlled space is unoccupied for substantial periods of time and out-of-range conditions can persist for significant periods, unnoticed. In one example, computer rooms and other buildings housing electronic or computer equipment need to be maintained at a cool temperature or the equipment will overheat, shut down, or otherwise be adversely effected by a failure of HVAC systems. Telephone and communication equipment, such as those associated with cell towers are often housed in climate-controlled structures proximate the cell tower. Such electrical and computing equipment must be maintained within a range of acceptable temperatures in order to function properly and not be damaged by out-of-range temperature conditions. Since cell towers and their associated structures are sometimes located in remote or inaccessible locations, such as at the top of tall buildings, mountains, water towers, etc., they are frequently unoccupied for lengthy periods of time and are therefore suitable for monitoring by the apparatus and methods of the present disclosure.

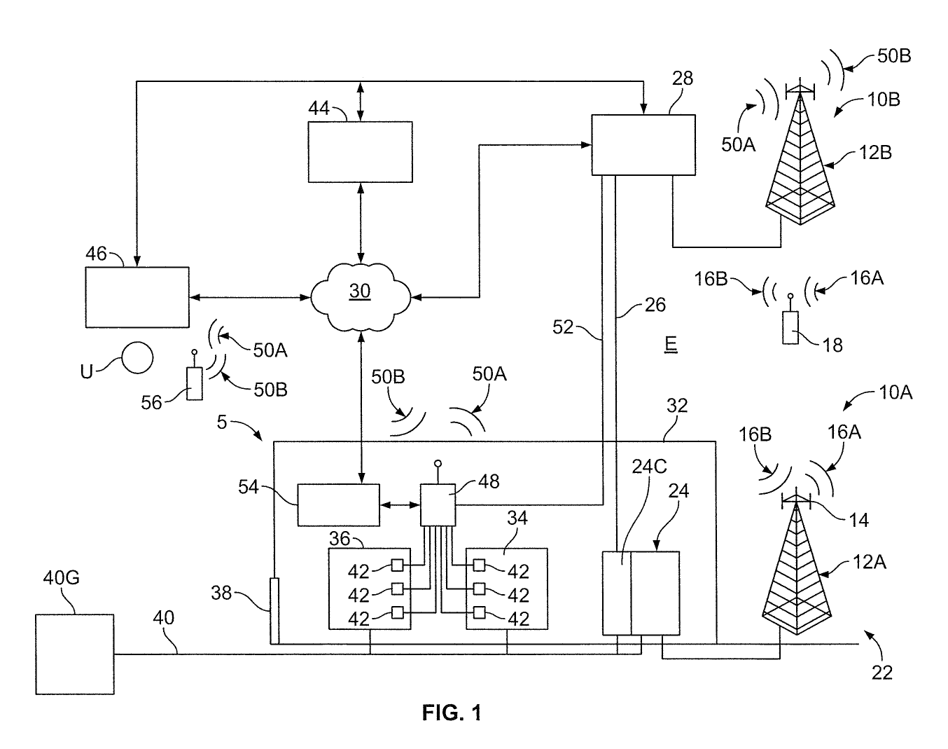

FIG. 1 shows a monitoring system 5 applied to a cell tower system 10A. A tower 12A elevates one or more aerials and/or microwave dishes 14 to a height promoting the reception and transmission of signals 16A, 16B to/from users' phones and wireless devices 18 and to/from other cell towers 12B in a cellular network 22. The communications between cell towers 12A, 12B (nodes) in the network 22 may be wireless or via wired or fiber optic lines (not shown). The signals 16A, 16B at cell tower system 10A emanate from or are received by transmitter/receiver (transceiver) 24, which typically includes a computer system 24C that controls the transmission and reception of the signals 16A, 16B and may connect with a wire or optical line 26 that connects to a node 28 in the network 22. Node 28 may communicate with the Internet 30. The line 26 that connects the cell tower system 10A to node 28 is typically a secure line and access to the line is guarded to prevent unauthorized access to the communications network 22. The transceiver 24 and computing and electrical gear 24C, hereinafter referred to collectively as “gear 24, 24C” associated with the cell tower system 10A may be housed in a structure 32, e.g., a frame or metal building that shields the gear 24, 24C from the weather. One or more HVAC units 34, 36 may be present in structure 32 to aid in climate control. The HVAC units 34, 36 may have air conditioning, heating and/or dehumidifying functions. Because electrical devices generate significant heat during operation, installations in most climates require air conditioning for at least some part of the year to prevent equipment overheating, damage and/or shutdown. The HVAC units 34, 36 may be of the same type, e.g., two air conditioners, offering redundancy in the case of a failure of one unit, e.g., 34 and/or additional heating/cooling capacity in case there is a need to have both units 34, 36 operating simultaneously, e.g., to address high temperature conditions that arises due to an extremely hot outside temperature in environment E, or to a window or door 38 of the structure 32 being opened and allowing hot air to enter the structure 32. Redundant HVAC units 34, 36 may also be used to alternate in maintaining climate control, in which case a first unit, e.g., 34, is assigned a “lead” designation to indicate that it is the unit that will be the primary unit for maintaining climate control for a given period. The other unit, e.g., 36, may be designated the “lag” unit, which is called upon to supplement the climate control function of the “lead” unit 34 when necessary, e.g., if two units 34, 36 are required to maintain a temperature, or if the lead unit suffers from degraded operation or breakdown. The “lead” and “lag” designations can be swapped periodically to distribute wear and tear on the units 34, 36.

An aspect of the present disclosure is an expansion of function beyond monitoring out-of-range temperature conditions or end state conditions after they have been reached, to continual monitoring of a variety of operational parameters of the HVAC systems 34, 36, and/or other conditions of the structure 32. This expanded monitoring may provide a dynamic view of the operational state of the systems 34, 36 and advance warning of the need for maintenance actions or impending conditions associated with degraded operation. Advance warning of impending or non-critical conditions or states of HVAC system 34, 36 allows maintenance, repair and replacement to occur prior to an emergency or problem state from happening. The present application discloses apparatus and methods for proactive trouble shooting and maintenance of HVAC systems, e.g., 34, 36. In addition to this proactive approach, reactive maintenance or response to malfunction indications, such as an over-temperature condition in a structure 32, may also be provided. To this end, the present disclosure presents a system and method for continually monitoring the performance, in real time (within a selected tolerance of time) of HVAC units, e.g., 34, 36 located at a remote site. Continual monitoring allows problems or degraded performance of the HVAC units 34, 36 to be observed early, allowing preventative action to be taken early, to reduce the cost, severity and frequency of repairs. This approach may minimize failures that negatively impact functionality at the protected site, e.g., a cell tower system 10A. In accordance with the present disclosure, this may be accomplished by monitoring parameters of the HVAC units 34, 36 and/or other conditions associated with the structure 32, such as the opened/closed state of windows and doors 38, the temperature within the structure 32 and in the environment E, the presence/absence of electrical power on line 40 from power grid 40G, the temperature of the computing and electrical gear 24C and transceiver 24, intrusion detection, fire, water and smoke detection, etc. In many instances, monitoring a variety of operational parameters, as well as environmental factors will yield insights into the operation and condition of the HVAC systems 34, 36 that will enable preventive maintenance. Preventive maintenance often avoids emergency breakdowns and frequently addresses a degrading condition early enough to avoid expensive repairs that would otherwise be needed if the degraded operation persists longer, resulting in a more serious or catastrophic malfunction.

The present disclosure provides for communicating the monitored parameters to a computer programmed with analysis software and/or to an operations center for analyzing the monitored parameters to identify nascent or existing problems, the need for maintenance, and identifying the type of maintenance needed. In one embodiment, the analysis may be used to schedule maintenance calls by service technicians and provide instructions, parts lists, etc. to the technicians to prepare them for the service required. More specifically, the parameters may be monitored by a plurality of sensors 42 as described further below, and the sensed data transmitted to a computer system 44 programmed to receive and analyze the monitored parameter data and report it to a user U, e.g., via a computer system 46 at an operations center. In one embodiment, the captured parameter data from sensors 42 is received by a data logger 48, capable of transmitting the data as a wireless output signal 50A, e.g., in the form a wireless/cellular telephone call, that may be received at cell tower systems 10A, 10B or any other cellular phone network node operated by any carrier offering wireless phone service to the data logger 48. Wireless data loggers 48 (WDLs) are available commercially, e.g., from Powelectrics Limited of Tamworth, Staffordshire, U.K., that may be modified in accordance with the present disclosure. For example, the WDL 48 may be modified to be able to support duct or cabinet enclosure temperature sensors, air flow meters and other types of sensors, as described below. The temperature sensors may be chosen to be accurate to <=1 degree F. The WDL 48 may accommodate sensor measurement every 5 or 15 minutes and may automatically send threshold breaks, i.e., on the occasion of a violation of a threshold criteria, the WDL 48 may immediately transmit the violating sensor data. In one embodiment, the WDL 48 may have an open protocol with APIs, be powered by +24 v and −48 v, with the WDL 48 providing power to sensors 42. The WDL 48 and sensors 42 may be selected to be suitable for indoor or outdoor applications. In one embodiment, the WDL 48 communicates sensor 42 data in near real time, e.g., every 5 and/or 15 minutes and would be capable of transmitting a plurality of sensor readings of an HVAC unit 34, 36, such as supply and return air temperature readings and air flow velocity. A variety of other sensors 42 may be employed to monitor other parameters, such as refrigerant pressures and electrical states.

A wireless output signal 50A from the WDL 48 may be suitable for remote installations where hard-wired telephone service is not conveniently available or would be expensive. In many countries, wired connections are not available at all locations. A wireless output signal 50A also avoids use of the secure line 26, to which communication companies do not wish to provide access, due to security concerns. In the alternative or as an optional backup, if available, a wired or optical line connection 52 could be used to connect to a public phone system and/or the Internet, e.g., at node 28, in order to transmit the monitored data from sensors 42. The monitored data may then be transmitted to computer 44 and/or computer 46, e.g., via a private network or the Internet 30. In one embodiment, the computer 44 is a server connected to the Internet 30 and is capable of processing the monitored data sent by data logger 48. In one embodiment, computer 46 may be a client computer connected to the Internet 30 that can connect to the computer 44 to receive raw data from the data logger 48 and the analysis/processed data generated by the analysis of computer 44. In another alternative, the computer 44 may be programmed to receive and analyze the data transmitted by the data logger 48 independently/redundantly from computer 44. Computer 46 may be located proximate user U, e.g., in a network operations center (NOC) of an HVAC monitoring and maintenance company.

In a further alternative, data logger 48 may output monitored data to a local computer 54 via a wired or wireless connection. Local computer 54 may be capable of conducting analysis and/or communicating with computers 44, 46, e.g., via the Internet or directly with the user U, who is visiting the cell tower system 10A. In one embodiment, a plurality of data loggers 48 are present at a site 10A, to monitor a larger parameter set and/or to provide for redundancy, in the event that one data logger 48 malfunctions. In another embodiment, the computer system 44, 46, 56 checks for the presence of a periodic data transmission from data logger 48 and if no transmission is received, generates a message to a user U that the anticipated transmission is absent.

In one embodiment, the data logger 48 output signals 50A are capable of being received by a mobile device 56, such as a smart phone or wirelessly connected computer 56 held by a user U. The mobile device 56 may be programmed with software permitting the analysis and other processing of the monitored data. In addition, the mobile device 56 may provide output signals 50B to the data logger 48 and/or the local computer 54 to control the data logger 48 and/or the local computer 54. For example a signal 50B may be used to adjust/select the parameters monitored or the rate of capturing or transmission of monitored parameters, e.g., increasing or decreasing the rate of output of signals 50A (from one call every 30 minutes to one call every 10 minutes) or the rate of data capture (from once every second, to once every 0.1 seconds). In another alternative, control instructions may be transmitted by the user U, by computers 46 or 44 through the Internet 30 to local computer 54 or to node 28 and transmitted as an output signal 50B2 receivable by the data logger 48 as input signal 50B.

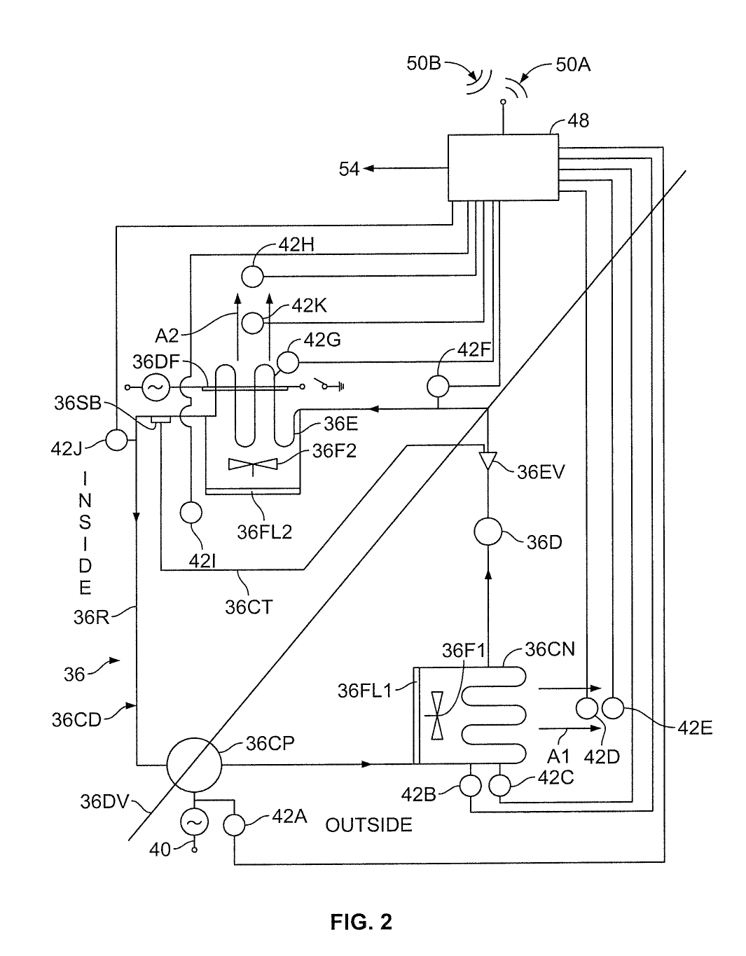

FIG. 2 schematically shows a conventional air conditioner 36 with a compressor 36CP, condenser 36CN, drier 36D, evaporator valve 36EV controlled by a sensor bulb 36SB and capillary tube 36CT, defroster 36DF and evaporator 36E. A refrigerant 36R travels thorough conduit 36CD connecting many of the foregoing elements. Fans 36F1 and 36F2 aid in heat transfer from the condenser 36CN to the outside and the evaporator 36E to the inside, respectively. The air conditioner 36 is divided between a hot (outside) portion and a cool (inside) portion by partition(s) and insulation illustrated by line 36DV. A plurality of sensors 42A-K are capable of monitoring various parameters and presenting the parameter data to data logger 48. The sensors 42A-K may monitor the presence and use of electrical power by sensor 42A, the temperature of refrigerant by sensor 42B entering condenser 36CN, the pressure by sensor 42C of refrigerant 36R entering condenser 36CN, air A1 temperature by sensor 42D passing over condenser 36CN, air velocity by sensor 42E exiting condenser 36CN, the pressure or temperature at any point in the refrigerant conduit by sensors 42F, 42G, 42J, air velocity by sensor 42K and/or air temperature by sensors 421, 42H of the air A2 entering/leaving evaporator 36E, respectively. The operational parameters sensed by sensors 42A-K may be used to assess the condition and operation of various components of the air conditioner 36. In accordance with an embodiment of the present disclosure, computers 44, 46, 54, 56 may analyze the sensed data to identify indicator(s) of degraded performance and/or the need for maintenance. In addition, the cause(s) for the downgraded performance or need for maintenance may be ascertained within a given probability of certainty. For example, if the refrigerant pressure and temperature are high at sensors 42B, 42C, but the air velocity and temperature measured by sensors 42D and 42E are unexpectedly low, the computer 44, 46, 54 and/or 56 could assess that compound condition to be caused by a blocked air filter 36FL1 or an inoperative fan 36F1 based on expert knowledge. At a second level of analysis, the power used, as sensed by sensor 42A, may be compared to a baseline power level associated with the air conditioner 36 operating normally, i.e., with compressor 36CP and fans 36F1 and 36F2 running and filters 36FL1 and 36FL2 unblocked (new). In the event that reduction in power consumption is present that closely matches a baseline power level with fan 36F1 disabled, then a first inference with a given level of certainty could be drawn that fan 36F1 is inoperative. Historical data pertaining to the age of the filters 36FL1 and 36FL2 and their percent blockage profile over time, as well as historical data showing the implications on power use associated with percent filter blockage may be also be considered in the programmatic analysis. For example, if a filter 36FL1 blockage of 60% corresponds with a similar variation in power used as a disabled fan 36F1, then the historical data showing the age of the filter and the historical rate of blockage over time may be consulted to see if filter blockage is a plausible cause of the low air A1 temperature and velocity. The correlation of measured parameters with historical/empirical patterns may be used to calculate a probability or degree of certainty for a given conclusion.

An identification of a problem or condition state can be translated into an action to remedy it. For example, the computer 44, 46, 54 or 56 may generate an alarm state or message to a user U to “change the air filter” 36FL1 on air conditioner 36. In one embodiment, the computer 44, 46, 54, 56 may feed the diagnostic information/conclusion to software that orders the appropriate repair parts, e.g., filter 36FL1, or generates a parts list and/or schedules a visit to the site for maintenance by a service technician and/or outlines the services that the technician should perform. By catching a relatively minor problem like a blocked filter, 36F1 early, inefficient operation, and unnecessary wear and tear on the air conditioner 36 may be avoided. Furthermore, earlier maintenance (while there is still a workable % blockage of filter 36FL1) avoids a more severe blockage that may prevent the air conditioner 36 from maintaining the temperature in the structure 32 at an acceptable level.

In the forgoing example, if the air velocity A1 were measured as normal, but the air temperature was low, indicating that the filter 36FL1 and fan 36F1 were operating normally, the temperature and pressure of the refrigerant 36R as measured by sensors 42B, 42C could be consulted. If there were a low temperature and low pressure condition at 42B, 42C, then this could be indicative of compressor 36CP malfunction, power loss, or a refrigerant 36R leak. Accordingly, the data from sensor 42A could be checked for the presence of electrical power and the data from other refrigerant pressure sensors, e.g., 42F or 42G in the refrigerant conduit 36CD refrigerant pressure checked. An aspect of the present disclosure is the recognition that a plurality or constellation of sensor 42 readings of different parameters taken at a given time and/or taken at different times may be of assistance in ascertaining the operation state of an HVAC system 36. Sensors 42 may also be provided (not shown) to sense environmental conditions, such as outside temperature and/or humidity, the opened/closed state of windows and doors 38 and the temperature inside the structure 32 at different locations.

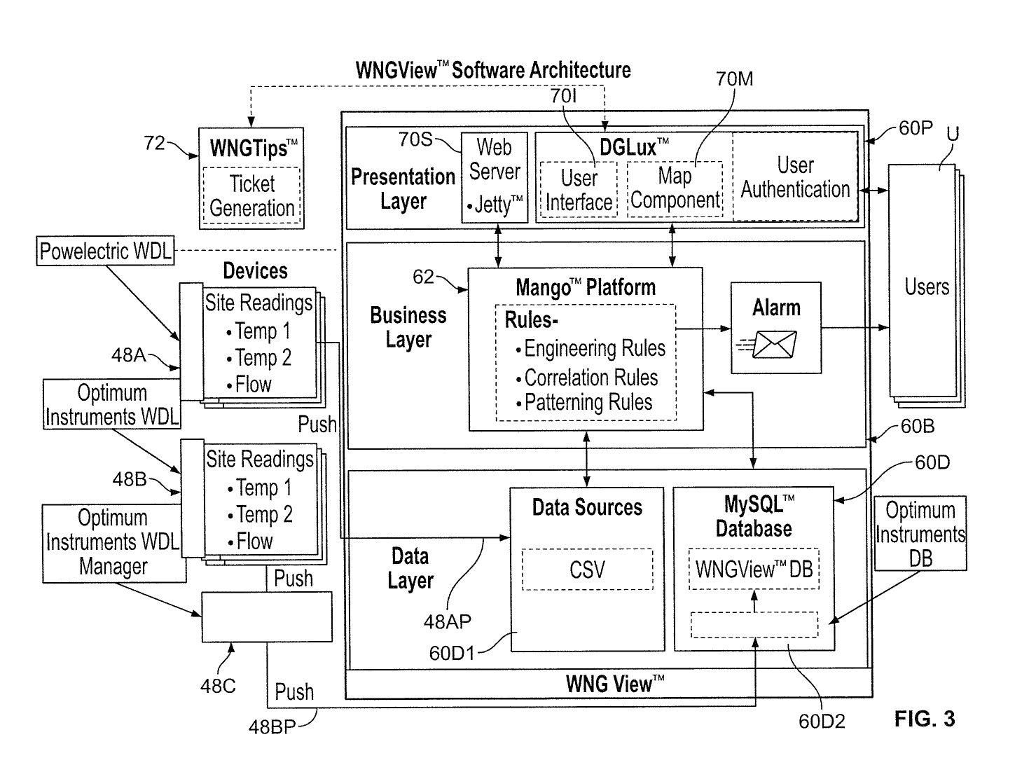

The foregoing example of logical analysis may be conducted by a programmed computer, e.g., any or all of computers 44, 46, 54, 56. For example, the analysis may be conducted by sequential code using if-then-else statements, or other conditional coding that describes a decision/diagnostic tree structure. In another alternative, a rules engine may be used to process a collection of rules, which check the values of measured parameters and execute responsive commands and actions, which may include the execution of additional rules, the generation of derivative data and conclusions, e.g., pertaining to causation. The rules may depend upon a plurality of variables (measured parameters), such that compound condition states can be evaluated. A rules-based program may allow the development of new rules and the deletion of old rules to provide for flexibility and on-going improvement in the logical analysis performed by the programmed computer 44, 46, 54, 56 without amending source code. More particularly, the programmed computer 44, 46, 54, 56 may present a user interface that can be used by non-programmers to enter, delete and vet rules for compatibility/conflict with existing rules. The rules may be stored in a rules database that supplies rules for execution by a rules execution core engine 62 (FIG. 3). The rules engine 62 may include a production rules engine that is invoked by a user and/or periodically and automatically and/or a reactive rules engine that reacts to events when they occur, e.g., a transmission of data from data logger 48 (FIG. 1). The program residing in computer 44, 46, 54 and/or 56 may store and time stamp the raw data received from the sensors 42/data logger 48, as well as analytical results, such as causation conclusions, remedial steps taken, and prologue reports as to the efficacy of the remedial actions. In this manner, continual operation of the monitoring system 5 results in a growing collection of data (in data layer 60D—FIG. 3) that may be used to identify patterns of operation, cause and effect, and improve the accuracy and effectiveness of the system 5. In one embodiment, a programmatic response to monitored data received from the data logger 48 is the setting of a logical state or flag, i.e., an alarm state, which may be graded along a given spectrum of significance and coded by color (e.g., Green (system o.k.), Yellow (caution—problem developing), Red (urgent condition requiring immediate attention)) or by number code. The alarm state may be communicated to a user U by the generation of text or graphics indicating the existence of the alarm state via a user interface of presentation layer 60P (FIG. 3).

FIG. 3 shows a diagram of a software architecture 60 in accordance with one embodiment of the present disclosure. The software has three layers, viz., a business layer 60B, a data layer 60D and a presentation layer 60P. A rules engine 62 evaluates a set of rules of various types, including engineering rules, correlation rules and patterning rules. Optionally, the rules engine 62 may be triggered by a site maintenance module using an access control list and scheduler. Scripts may optionally be employed to evaluate rules or be triggered as the result of the evaluation of rules by the rules engine 62. The core rules engine 62 rapidly collects data received from the sensors 42/data logger 48, then analyzes the data, applying conditional logic, equations/thresholds, correlations and patterns. In one embodiment, the analysis may be defined and redefined by the rules. In accordance with one embodiment, the system 5 becomes “smarter” over time as more and more data accumulates, leading to more accurate correlation of data to causation and the refinement of insights from empirical feedback. A rules engine approach facilitates an end-user with expertise and experience to rapidly implement new/smarter rules as new knowledge and insights evolve. As a consequence of the evaluation of rules, outputs representing states of concern or alarms 70A may be sent to a user U. The rules are evaluated by the rules engine 62 based upon data 60D1, 60D2 received from the data loggers 48A, 48B, respectively, which are communicated via push 48AP, 48BP to a data server, e.g., at node 28 (See FIG. 1). The pushes 48AP, 48BP may be done via a wireless connection. Two data loggers 48A, 48B are shown, which may be at one site, e.g., 10A or at a plurality of different sites 10A. The system 5 may use any number of data loggers 48 at any number of sites. The data loggers 48A, 48B may be of the same type or of different types. For example, in one embodiment, data logger 48A may be a Powelectrics Limited wireless data logger (WDL) and data logger 48B may be a WDL obtained from Optimum Instruments, Inc. of Alberta, Canada. Each data logger 48A, 48B may be capable of capturing and transmitting a plurality of types of sensor data, e.g., temperature, airflow rate and other types of data. Data pushed from data logger 48A may be in the form of a table of comma-separated values (CSV), which is then made available to the rules engine 62. Data pushed from data logger 48B may pass through an Optimum Instruments WDL manager 48C and be received in a database formatted in accordance with a database program, such as MySQL™ from ORACLE Corporation of Redwood Shores, Calif., USA. The data 60D1, 60D2 may be time-stamped operating parameter data gathered by the data loggers 48A, 48B over time, as well as diverse other data for reference, such as, prior analysis results, setpoints/thresholds, anticipated useful life data, service records, etc. The presentation layer 60P presents the data 60D1, 60D2 in raw and processed form, e.g., representing the analysis conducted by the rules engine 62, to a user U, e.g., using a computer 44, 46, 54, 56 with a visual display monitor and/or printer. The rules engine may be implemented using Mango Automation™ software from Infinite Automation Systems, Inc. of Rutherford NSW, Australia. The presentation layer 60P may utilize a web server, e.g., Jetty™, available from the Eclipse Foundation of Ottawa, Calif., running on, e.g., computer 44 that presents the data 60D1, 60D2, in raw and processed form to another computer, e.g., computer 46, 54 or 56 over the Internet. In so presenting the data 60D1, 60D2, the presentation layer 60P may express it using a graphical user interface optionally featuring an alarm dashboard, a history of alarms and real time alarm notifications. DGLux™ from DGLogik™ of Oakland, Calif. or other interface software may be used in presenting the data to the user U, i.e., in forming the user interface 70I. The user interface may also present a map component 70M, since the data pertains to physical sites, which have a map location. Weather information is readily available for any given geographic location and may be provided on the user interface 70I. The presentation layer 60P may also generate data and control signals to an automated technician “ticketing system,” 72, i.e., a system that generates instructions (“tickets”) to technicians to conduct service calls. A “ticket” may include address, map information, trouble description, equipment description, a needed parts list and a list of recommended repair and/or testing procedures. A commercially available system of this type is offered by the assignee of the present application, Wireless Network Group, Inc. of Pompton Plains, N.J., USA and is identified by the tradename WNG Tips™.

As noted above, the system 5 can collect and analyze data to determine if any alarm conditions have arisen and bring that to the attention of users U, e.g., at a Network Operations Center (NOC). The techniques involved in the analysis (rules) may include basic calculations (e.g., calculating a temperature differential, an average temperature differential or temperature differential change over time), correlation algorithms and patterning techniques. These techniques may be used to isolate significant problems and symptoms and may identify nascent problems that will eventually trigger a more extensive malfunction. This allows a user U to focus on more significant problems and symptoms to distribute remedial assets more quickly, effectively and efficiently.

### Basic Calculations

There are several basic HVAC calculations (rules) that may be used to assess monitored data, such as, temperature differential, which is the difference between supply air temperature (air cooled by passing over evaporator 36E) and return air temperature (air temperature inside structure 32 prior to passing over evaporator 36E) at any given point in time when the unit is operating (as indicated by compressor 36CP and fan 36F2 and/or 36F1 operating). An exemplary temperature differential (TD) for an HVAC unit 34 or 36 of a cell tower system 10A could be 25 to 30 degrees Fahrenheit to be considered operating normally and properly sized. A temperature differential less than this may indicate a degradation of function warranting investigation and or repair. Of course, a primary condition for a temperature differential of this magnitude is that the HVAC unit, e.g., 36 is operating. In one embodiment, the analysis may reference one or more previous temperature differentials (PTDs) associated with an earlier state of the HVAC unit 36 to detect any significant changes in the temperature differential from one point in time to another. As noted above, air velocity may be measured (e.g., in meters per second) while the air conditioner 36 is operating in order to detect changes in the speed of air flow being delivered by fans 36F1 and 36F2. An acceptable range of air velocities will vary for the specific unit 36, but may, e.g., be about 30 m/sec. Air velocity changes may be used to monitor fan cycles, i.e., the on/off cycles that an air conditioner 36 performs in an hour, which may be counted. The number of cycles is counted based on the observed changes in the value for air flow. One full fan cycle may be defined by the value of air flow going from a value that is greater than one (>1) to a value that is less than one (<1) and back again to a value greater than one (>1). As mentioned above, “lead/lag” is an HVAC setup where there are two HVAC units 34, 36, but only one operates as the principle unit at any given time. The unit that is called into operation as the primary unit for a given time period is called a lead unit while the other is called the lag unit. Lead and lag units swap periodically as to which unit is called into operation as the primary unit. Lead/Lag may be expressed in the number of days e.g. 8 days that a unit 34, 36 is designated the lead or lag unit.

With the foregoing in mind, a first technique for analyzing performance of an HVAC unit 34, 36 would be to set and monitor thresholds (a low end and high end set of values) for measured parameters, ether singly or in sets. If a threshold is breached, this may trigger an alarm condition. The following are exemplary thresholds and associated alarm conditions:

### 1. Temperature Differential (TD) by Unit

A temperature differential threshold (TD) may be determined for a particular HVAC unit 34, 36, installed at a specific location, e.g., as determined by expert knowledge of the air conditioner manufacturer and/or the installer pertaining to the type of unit and the attributes of the installation site, e.g., a cell tower system 10A. The operational characteristics of the air conditioner 34, 36 when it is first installed may be taken into consideration when setting the thresholds in the criteria rules. In one example, the temperature differential threshold may be set to 15 degrees F. If the measured temperature differential is less than the threshold by 5%, then a Yellow alarm may be set and communicated to the user U. If the temperature differential is less than 10% than the threshold then a Red alarm may be generated. Here is a table of a set of exemplary data.

| Return Air Temp | Supply Air Temp | Air Flow | TD | Alarm State |
|---|---|---|---|---|
| 77° F. | 54° F. | 8 m/s | 23° F. | Yellow |
| 75 | 60 | 8 | 15 | Red |
| 75 | 60 | 0.5 | 15 | No Alarm |

If the TD threshold is set to 24 degrees F., then the temperature differential of 23 in the first line of the foregoing table is about 4% less than the threshold. Because the TD is below the threshold and the air flow of 8 m/sec indicates that the air conditioner is running, then an alarm is set. Because the deficiency in the TD is not severe, a yellow alarm is set. In the second line, a temperature differential of 15 is lower by about 9 degrees F. than the threshold of 24 degrees F. and is therefore about 37% lower than the threshold, indicating a more severe degradation of the temperature differential. Since this deficiency in the temperature differential is significant, a red alarm is set. In line three in the table above, even though the temperature differential is 37% lower than the threshold, no alarm is set because the air flow of 0.5 m/sec is indicative of the air conditioner being off.

### 2. Air Velocity by Unit

As with the temperature differential threshold, a threshold fan air velocity, e.g., of fan 36FL2, may be determined specifically for a particular HVAC unit 34, 36, installed at a specific location, e.g., as determined by expert knowledge of the air conditioner manufacturer and/or the installer pertaining to the type of unit and the attributes of the installation site, e.g., a cell tower system 10A. In one example, the threshold fan air velocity may be 8, 20, 30 or more m/sec. The operational characteristics of the air conditioner 34, 36, when it is first installed, may be taken into consideration when setting the thresholds and alarm levels. In one example, if the measured air velocity is degraded by 5% relative to the threshold, then a Yellow alarm may be set and communicated to the user U. If the air velocity degrades by 10% relative to the threshold, then a Red alarm may be generated. An exception may exist if air velocity is <=1 m/sec., indicating that the air conditioner is off and then no alarm is set.

### 3. Average Temperature Differential

The average temperature differential may be calculated by averaging a plurality of temperature differentials of supply and return air temperatures over a period of time, e.g., over 6 hours. In one example, if the average temperature differential is less than or equal to 15 degrees F., then a Yellow alarm may be set and communicated to the user U. If the temperature differential is less than or equal to 10 degrees F., then a Red alarm may be generated. The threshold values noted above may be set and adjusted by the user U via the computers 46, 44, 54, 56, e.g., by generating new rules or by editing old rules.

In addition to the use of thresholds, the system 5 may also use correlation techniques to analyze data obtained from the sensors 42 and communicated by the data logger(s) 48. Correlation is a statistical technique that is used to measure and describe the relationship between two or more variables, in this case, measured parameters, and conclusions as to state or condition, e.g., blocked filter 36FL1, inoperative fan 36F1, low refrigerant 36R level, etc. Correlation typically requires at least two data values from two different sensors, e.g., 42D, 42E to determine if there is strong correlation to a problem state/condition that warrants attention. In some instances, a single data value, e.g., a lack of power sensed by sensor 42A may be sufficient to make a correlation to a problem state. Correlation may also be used to identify situations/conditions where an apparent problem state exists based upon the evaluation of some parameters which result in an alarm state being set, but upon the evaluation of additional parameters, it is established that the alarm is a false alarm. For example, a high temperature condition may be identified by an ambient temperature reading in structure 32, which generates an over-temp alarm, but a door sensor indicating that the door 38 is open in conjunction with an outdoor temperature sensor which indicates that the outside temperature is 95 degrees F., may indicate that the air conditioning unit 34 is functioning normally and hence the alarm is a false alarm. The over temperature alarm may be further placed in perspective, by the computer 44, 46, 54, 56 ascertaining from the database 60D3, that a service call by a technician was scheduled for the time that the over-temperature condition was sensed. As a result, the computer may set a timer to recheck the condition for verification that the temperature returns to normal within a set amount of time, before setting an alarm condition.

Further to explaining correlation techniques that may be implemented by the system 5, what follows are a few examples of correlation rules that may be evaluated by rules engine 62.

1. If HVAC Unit 34 and HVAC Unit 36 are both running at the same time, then a Yellow alarm is set and communicated to the user U.

2. If HVAC Unit 34 and HVAC Unit 36 are both running (airflow>1 m/sec.) for more than 30 minutes at the same time, then a Red (highest priority) alarm is set and communicated to the user U.

3. If HVAC Unit 34 or HVAC Unit 36 is Off (airflow<1 m/sec) and there is a Lead/Lag, then ignore temperature differential.

4. If air velocity for a unit 34 is >1 m/sec, the fan 36F2 is cycling properly and temperature differential is increasing, then set a Yellow alarm.

5. If air velocity >1 m/sec and the fan 36F2 is running continuously and air temperature=50 to 52 degrees F., no alarm, otherwise set Yellow alarm.

In addition to correlation techniques, the system 5 may also use patterning or pattern recognition. Pattern recognition is a branch of artificial intelligence concerned with the classification or description of observations. Pattern recognition aims to classify data (patterns) based on either expert knowledge or statistical information extracted from historical/empirical operational patterns. A complete pattern recognition system consists of a sensor that gathers the observations to be classified or described; a computation from the observations; and a classification or alarm condition. One example is monitoring airflow over time to determine if the operational pattern of airflow observed is consistent with an HVAC unit 34, 36 that is operating properly.

Patterning looks at statistical trends over time to proactively detect problems before they become a bigger problem later. What follows are a few examples of rules evaluating measured parameters using patterning techniques.

1. If, over a period of time, the fan 36F2 of the primary (Lead) unit, e.g., 34 is cycling

ON (Air velocity >1 m/sec) continuously: a) for more than 6 hours, then set and communicate a Yellow alarm; or b) for more than 12 hours, then set and communicate a Red Alarm.

2. If the site, e.g., 10A, has Lead/Lag devices 34, 36 then a current lead unit 34 should operate for 8 days (or whatever time period is appropriate for the site 10A, site specific entries being permitted). Any more or any less, generates an alarm condition. Operation of the lead unit 34 is indicated, inter alia, by the fan 36F2 cycling on/off as the temperature within the structure 32 goes above and then returns below a temperature set point/range. The operation of the fan is indicated by air velocity/flow sensor 42H. A pattern or fan cycle may be defined as a continuous set of fan 36F2 on/fan 36F2 off states as indicated by air velocity sensor 42H for the period that the lead unit 34 is assigned the lead role, e.g., 8 days. If the lead unit 34 operates for a different length of time (as indicated by the fan cycle, then this may result in an alarm condition being set. If the fan cycle extends: a) for more than 8 days, then a Yellow alarm is set and communicated to the user U (As noted above, this cycle duration may be site specific.); b) for more than 9 days, then a Red alarm is set; c) for less than 8 days, then a Yellow alarm is set; or d) for less than 7 days, then a Red alarm is set.

4. Previous Temperature Differential (PTD)—Temperature Differential Changes over time

The change in temperature differential (TD) over time may be used to identify events or trends indicating present or imminent degradation of function. In one embodiment, the current temperature differential (TD) may be compared to the previous temperature differential (PTD) to determine is an alarm should be set. The following are examples of criteria comparison of the current and previous temperature differentials which are shown in the following table.

IF Current TD vs. PTD is increasing then no alarm (line three in the table);

IF Current TD vs. PTD is decreasing by >=2 degrees, but TD is within Threshold (Green, e.g., Threshold=30), then set Temporary Yellow alarm and do not display on dashboard (line 1 in the table);

IF Current TD vs. PTD is decreasing by >=2 degrees and Current TD breaches TD threshold, then set Yellow (lines two and four) or Red Alarm (line five) depending on TD threshold rules in place, e.g., if TD<=Threshold-5 or TD<=Threshold and TD<=PTD-5, then set Red alarm.

| Current TD | Previous TD | |
|---|---|---|
| (Degees F.) | (Degrees F.) | Alarm |
| 30 | 36 | Temporary Yellow |
| 28 | 30 | Yellow |
| 36 | 28 | No Alarm |
| 29 | 36 | Yellow |
| 25 | 30 | Red |

The system 5 permits a user U to easily add new or site specific patterns without programming, i.e., by generating new rules for processing by the rules engine 62.

### Focused Reporting Structure

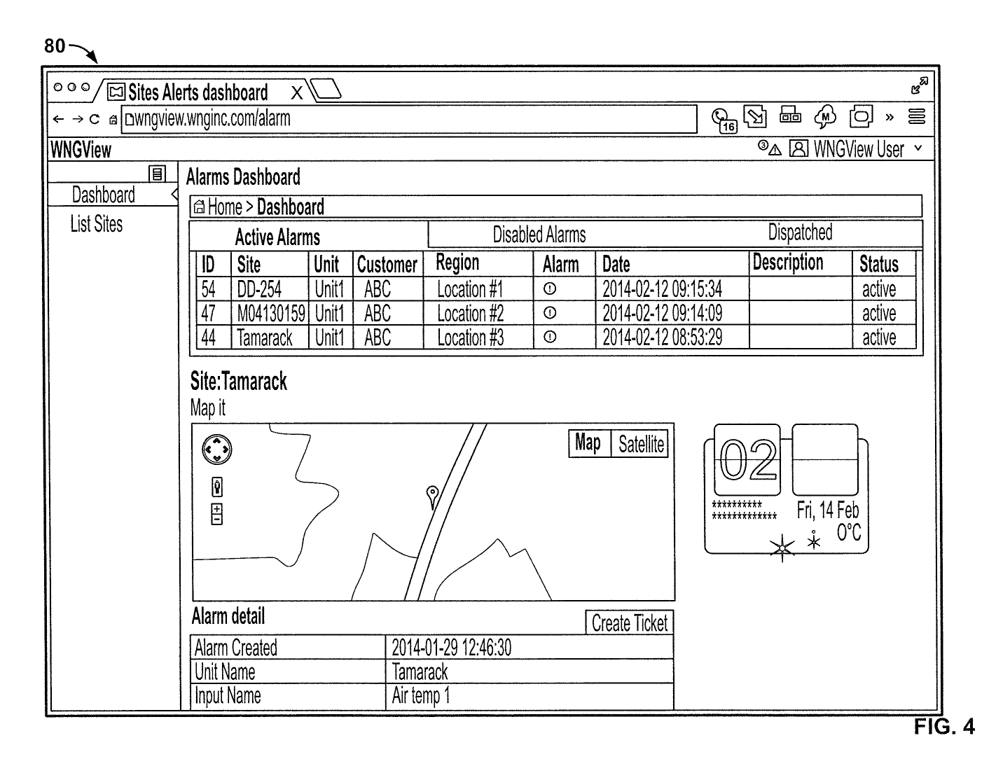

Having analyzed sensed parameters in one or all of the computers 44, 46, 54, 56, the system 5 may then report the results of that analysis to the user U. The system 5 may use the approach of “Management By Exception.” FIG. 4 shows a dashboard type of user interface 80 that is presented to a user(s), e.g., NOC operators, to focus their attention on alarm conditions that have arisen at the sites, e.g., 10A, monitored by the system 5. The dashboard presentation 80 allows the user U to “drill down” to get all the relevant details and readings for a particular unit at a given location, e.g., cell tower system 10A. In the embodiment shown, alarms are categorized into Red, Yellow and Green which are used for reporting/alerting and are defined as follows: a) Red Alarms—are urgent conditions that require immediate attention; b) Yellow Alarms—are warning conditions that a problem situation is developing; and c) Green Alarms—all is okay. The dashboard 80 may list all Active alarms (new ones), Disabled Alarms (those to ignore) and Dispatched Alarms (those already dispatched for repair).

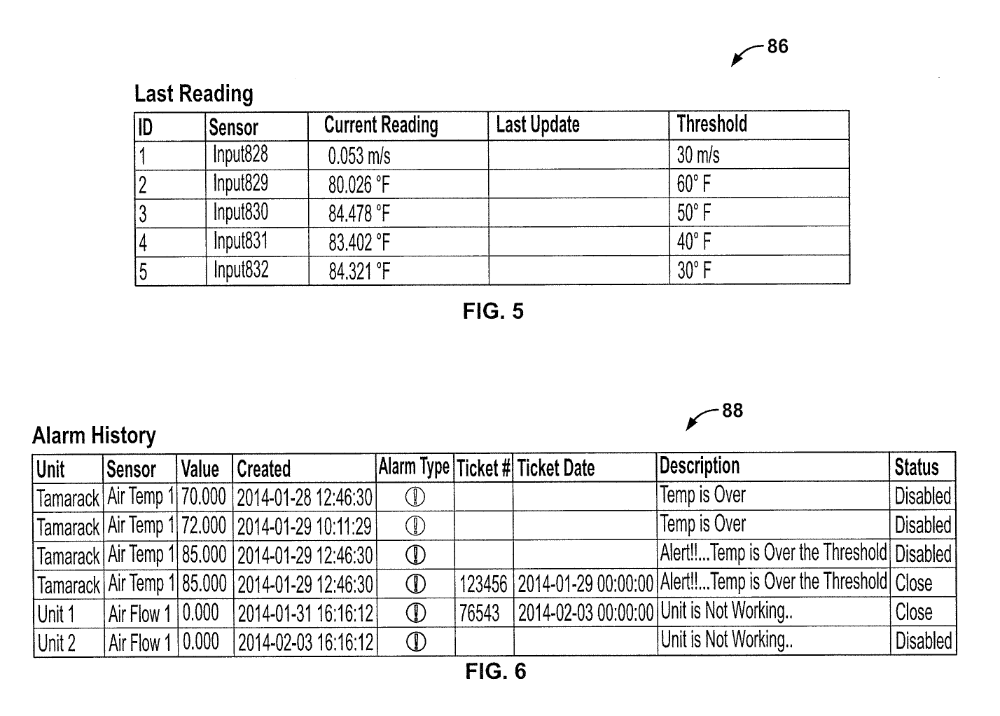

FIG. 5 shows a drill down report 86 that shows a plurality of the most recent sensor readings for an HVAC unit, such as air conditioner 34, over a period of time. The sensor “Input828” reported on line 1 is an air velocity sensor and the last reading is in m/sec., i.e., 0.053 m/s (meters/second), indicating that the fan unit that would raise the velocity to or near the threshold of 30 m/s is OFF. The sensor “Input 829” is a temperature sensor, showing a reading of 80.026 degrees F., which is over the threshold of 60 degrees F. As explained above, a temperature threshold may be established, e.g., a temperature that should not be exceeded for the computer hardware protected by the HVAC unit(s) at a given site. In addition, threshold may be expressed as temperature differential thresholds, i.e., between the return and supply air. The system permits the user U to develop custom reports on an “ad hoc” basis, e.g., to get unit 34 history and readings.

FIG. 6 shows a report 88 of alarm history for sensors of HVAC units, e.g., air conditioners 34, noting the type of sensor, e.g., air temperature, air flow, etc. and the measured value which generated the alarm, the time of measurement, the type of alarm generated, the ticket number and date of the ticket generated to the technician, the description of the nature of the malfunction and the current status of the associated equipment.

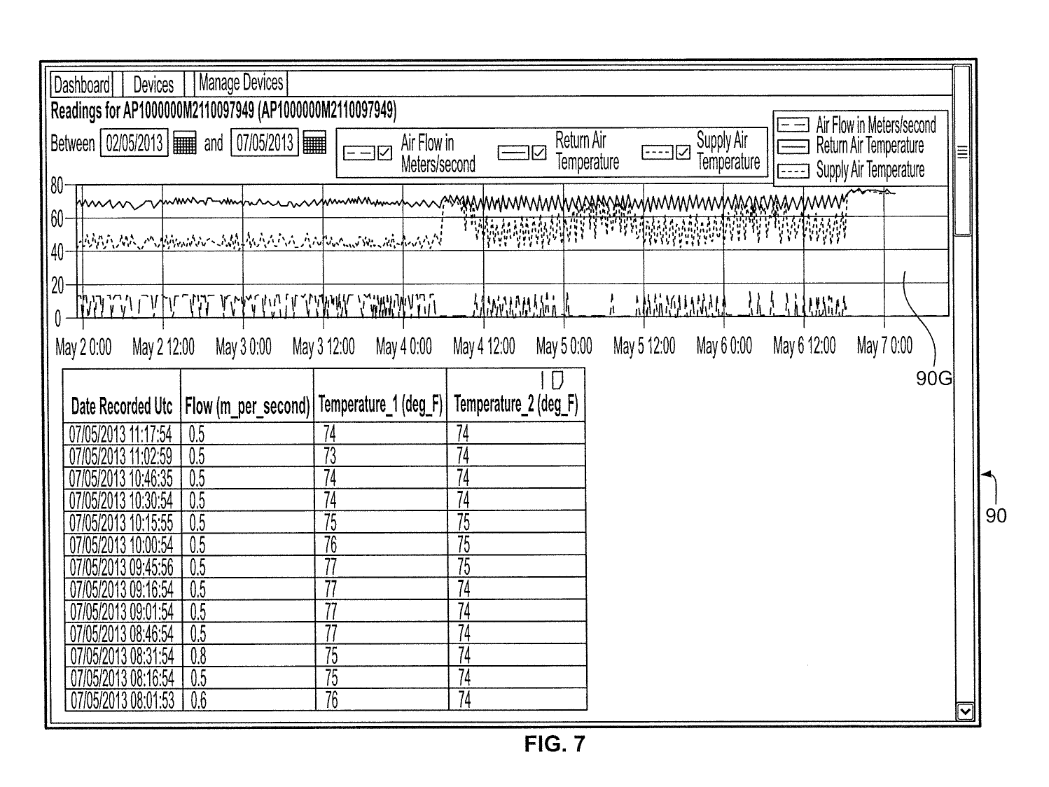

FIG. 7 shows a report 90 with a graph 90G of return and supply air temperature and air flow over several days for a given HVAC unit. As can be appreciated from the graph, the temperature differential between the return air and supply air was stable for May 2 through the morning of May 4 and then conditions changed with the supply and return temperatures oscillating more severely, the temperature differential shrinking significantly on several occasions and the supply air temperature exhibiting an average increase. These results could be indicative of different causative conditions, such as a significant rise in outdoor temperature, a door or window being left open or a blocked air filter, etc.

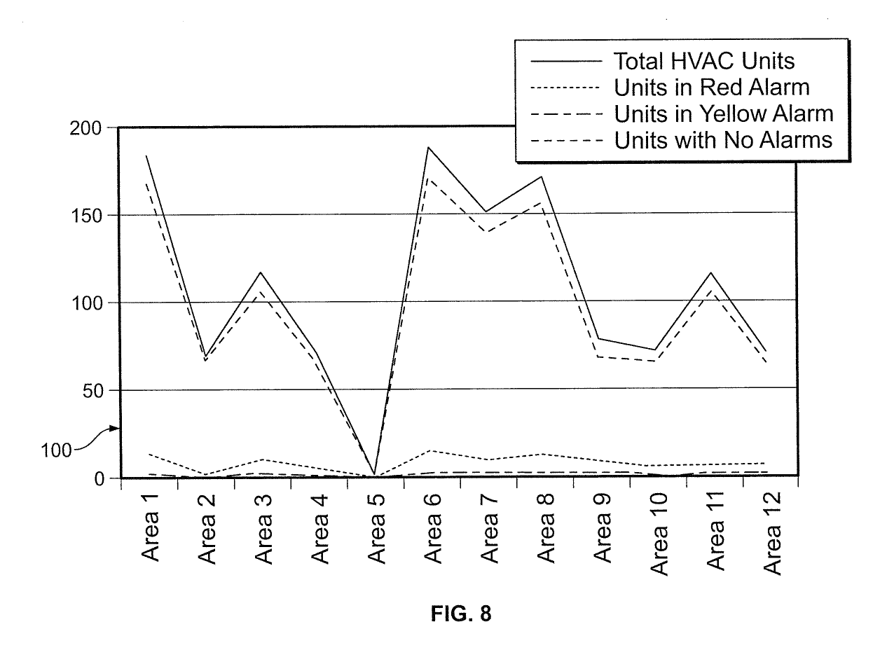

FIG. 8 shows a graph 100 of an alarm summary for a given period, e.g., one month. This report provides statistics on the distribution of alarm data by type, e.g., Green (all ok), Yellow (alert), Red (in trouble) for a given month. The graph 100 was generated by taking a daily snapshot of the latest alarm state for each unit, at all sites, every day at midnight. If a unit has more than one alarm, the worst alarm state, i.e., red (over yellow) would be counted for that unit. On the first day of each month, a “Monthly Alarm Summary” may be generated by averaging the “daily snap shot reports” of the previous 28, 30 or 31 days.

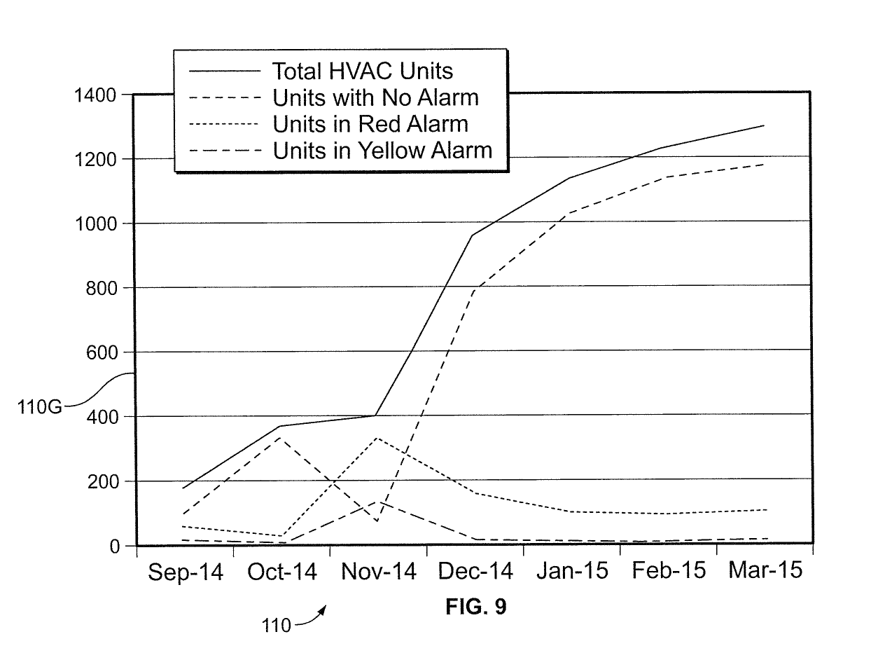

FIG. 9 shows an alarm trending report 110 with a graph 110G of the total number of HVAC units monitored, the units with no alarm experience, the units that had a red alarm and the units that had a yellow alarm over a period of about six months. This report provides insights on the alarms over a period of time to see if maintenance actions and the operation of the system are having a positive effect, i.e., showing that the number of red and yellow alarms are declining over time.

It will be understood that the embodiments described herein are merely exemplary and that a person skilled in the art may make many variations and modifications without departing from the spirit and scope of the disclosure. All such variations and modifications are intended to be included within the scope of the appended claims.

We claim:

1. A system for monitoring operation of remote apparatus, comprising:
at least one sensor capable of sensing at least one operating parameter of the apparatus and generating data corresponding to the at least one operating parameter at a plurality of times;
a computer programmed to analyze the data to identify out-of-range operating conditions for the apparatus;
means for communicating the data from the at least one sensor to the computer, the computer capable of communicating the prediction of impending out-of-range operation to a user.

2. The system of claim 1, wherein the computer is programmed to predict impending out of range operation based upon data corresponding to the at least one operating parameter.

3. The system of claim 2, wherein the apparatus is HVAC equipment.

4. The system of claim 3, wherein the HVAC equipment is installed in a structure controlling the temperature of electronic equipment associated with a communications cell tower.

5. The system of claim 1, wherein the means of communicating the data is a data logger.

6. The system of claim 5, wherein the data logger communicates wirelessly via a cell phone call.

7. The system of claim 1, wherein the at least one sensor includes a plurality of sensors, each capable of sensing on a different operating parameter of the apparatus.

8. The system of claim 3, wherein the at least one sensor includes a plurality of sensors, each capable of sensing on a different operating parameter of the apparatus, including sensors for sensing supply and return air temperature and air flow velocity.

9. The system of claim 2, wherein the computer is capable of ascertaining a diagnosis of the cause of the impending out-of-range operating conditions for the apparatus and communicating the diagnosis to the user.

10. The system of claim 9, wherein the computer is capable of prescribing a course of action to the user to remedy the impending out-of-range operating conditions for the apparatus before they occur.

11. The system of claim 10, wherein the course of action is expressed in a directive to a service technician.

12. The system of claim 11, wherein the directive includes a repair parts list.

13. The system of claim 1, wherein the out-of-range operation communicated to a user is expressed as an alarm state having a selected urgency indication.

14. The system of claim 8, wherein the at least one sensor includes sensors capable of sensing on at least one of fan cycles, lead/lag, refrigerant pressure and refrigerant temperature.

15. The system of claim 8, wherein the at least one sensor includes sensors capable of sensing on at least one of conditions of the environment and conditions of the structure in which the HVAC unit is installed.

16. The system of claim 1, wherein the analysis conducted by the computer is a rules based analysis.

17. The system of claim 2, wherein the analysis conducted by the computer utilizes pattern recognition.

18. The system of claim 2, wherein the analysis conducted by the computer utilizes empirical data collected from operation of the apparatus.

19. The system of claim 2, wherein the analysis conducted by the computer utilizes empirical data collected from operation of other apparatus similar to the apparatus.

20. The system of claim 2 wherein the out-of-range operating condition is identified from at least one of temperature differential between return air temperature and supply air temperature and air flow.
